(19) United States
(12) Patent Application Publication
(10) Pub. No.: US 2006/0059711 A1
(43) Pub. Date: Mar. 23, 2006

(54) Latch assembly and drying machine having the same

(75) Inventors: Jin Doo Kim, Suwon-City (KR); Woo Sup Jung, Suwon-City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/127,094

(22) Filed: May 12, 2005

(30) Foreign Application Priority Data
Sep. 20, 2004 (KR) 2004-75193

(51) Int. Cl. F26B 17/24; F26B 17/30

(52) U.S. Cl. 34/603; 34/58

(57) ABSTRACT

A latch assembly, which is simply and rapidly assembled, and a drying machine having the same. The latch assembly is installed in the front panel of the drying machine, and a hook, which is locked to or unlocked from the latch assembly, is installed on a door of the drying machine. The latch assembly includes a latch main body having protrusions and fixing holes at opposite sides thereof, and a latch cover having protrusion-receiving holes and fixing protrusions at opposite sides thereof. The protrusions are formed on an operating portion extended from a base portion of the latch main body, and the fixing holes are formed in the base portion just below the protrusions. The protrusion-receiving holes are formed in an extended portion extended from the edge of a planar portion of the latch cover, and the fixing protrusions are formed on ends of the extended portion of the latch cover. When the latch cover is inserted into the latch main body, the protrusions are caught by the protrusion-receiving holes and the fixing protrusions are inserted into the fixing holes, thereby assembling the latch cover with the latch main body in a one-touch fashion.

### CROSS-REFERENCE TO RELATED APPLICATION

This application claims priority from Korean Patent Application No. 2004-75193, filed Sep. 20, 2004, in the Korean Intellectual Property Office, the disclosure of which is incorporated herein by reference.

### BACKGROUND OF THE INVENTION

1. Field of the Invention

An apparatus consistent with the present invention relates to a latch assembly, which is simply and rapidly assembled, and a drying machine having the same.

2. Description of the Related Art

Generally, each of a drying machine and a washing machine comprises a cabinet having an opening formed through the front surface thereof, and a door installed at the front surface of the cabinet for opening and closing the opening, thereby allowing laundry to be put into or taken out of the cabinet through the opening under the condition that the door is opened. Further, in the same manner as the drying or washing machine, a dishwasher comprises a cabinet having an opened front surface, and a door installed at the front surface of the cabinet, thereby allowing dishes to be put into or taken out of the cabinet under the condition that the door is opened.

In each of the washing machine, the drying machine, and the dishwasher, which has a structure in which a latch assembly is installed on the cabinet and a hook is installed on the door, when the door is pushed toward the front surface of the cabinet, the hook is inserted into the latch assembly, thereby causing the door to close the opening of the cabinet. Further, when the door is drawn by force having a designated intensity, the hook is separated from the latch assembly, thereby causing the door to open the opening of the cabinet.

For example, Korean Patent Laid-open Publication No. 10-2004-0046964 discloses a latch assembly, comprising a latch main body having a pair of holders and springs, and a latch cover installed on the front surface of the latch main body, and a drying machine having the latch assembly.

The latch assembly disclosed by the above Korean Patent Publication has a structure such that the latch main body and the latch cover are connected by a plurality of screws, thereby being disadvantageous in that it has a complicated assembly process and an increased assembly time.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

Therefore, an aspect of the invention is to provide a latch assembly, which is simply and rapidly assembled, and a drying machine having the same.

In accordance with one aspect, the present invention provides a latch assembly comprising: a latch main body for locking or unlocking a hook installed on a door; and a latch cover for covering the latch main body, wherein the latch main body includes at least one protrusion, and the latch cover includes at least one protrusion-receiving hole, by which the protrusion is caught, so that the latch main body and the latch cover are assembled in a one-touch fashion.

The latch main body may include a base portion, and an operating portion perpendicularly extended from a surface of the base portion, and the latch cover may include a planar portion, and an extended portion perpendicularly extended from an edge of the planar portion, so that the extended portion of the latch cover covers the operating portion of the latch main body.

A pair of the protrusions may be formed on an outer surface of the operating portion of the latch main body such that the protrusions are opposite to each other, and a pair of the protrusion-receiving holes corresponding to the protrusions may be formed in two sides of the extended portion of the latch cover such that the protrusion-receiving holes are opposite to each other.

Fixing protrusions may be formed on ends of the opposite sides of the extended portion of the latch cover provided with the protrusion-receiving holes, and fixing holes, into which the fixing protrusions are inserted, may be formed in the base portion of the latch main body, thereby allowing the latch cover to be firmly fixed to the latch main body.

The inside of the operating portion of the latch main body may be divided into a first space, a second space, and a third space communicating with the first and second spaces; and a first spring and a first holder may be installed in the first space, and a second spring and a second holder are installed in the second space, so that the hook is locked or unlocked by the action of the first and second springs and the first and second holders.

Each of the first and second holders may include a guide protrusion protruding toward the planar portion of the latch cover, and a pair of guide holes for receiving and guiding the guide protrusions may be formed through the planar portion of the latch cover, thereby allowing the first and second holders to move stably back and forth.

Each of the first and second holders may include a latch unit protruding toward the third space so that the first and second holders are pushed toward the third space by the first and second springs, thereby causing both side surfaces of the hook to be caught and locked by the latch units.

In accordance with another aspect, the present invention provides a drying machine comprising a front panel having an opening, a door hinged to the front panel to open and close the opening, a hook installed on the door, and a latch assembly installed in the front panel for locking and unlocking the hook, wherein the latch assembly includes a latch main body having at least one protrusion, and a latch cover having at least one protrusion-receiving hole, by which the protrusion is caught, so that the latch main body and the latch cover are assembled in a one-touch fashion.

A plurality of screw holes may be formed in the base portion of the latch assembly, thereby connecting the latch assembly to the front panel using screws.

### BRIEF DESCRIPTION OF THE DRAWINGS

These and/or other aspects and advantages of the invention will become apparent and more readily appreciated from the following description of the exemplary embodiments, taken in conjunction with the accompanying drawings, in which:

FIG. 1 is a front perspective view of the external appearance of a drying machine having a latch assembly consistent with the present invention;

FIG. 2 is a rear perspective view of a front panel provided with the latch assembly, shown in FIG. 1, connected to the rear surface thereof;

FIG. 3 is an exploded perspective view of the latch assembly consistent with the present invention;

FIG. 4 is an assembled perspective view of the latch assembly consistent with the present invention; and

FIG. 5 is a longitudinal-sectional view taken along the line V-V of FIG. 4.

### DETAILED DESCRIPTION OF THE ILLUSTRATIVE, NON-LIMITING EMBODIMENTS OF THE PRESENT INVENTION

Reference will now be made in detail to an exemplary embodiment of the present invention, an example of which is illustrated in the accompanying drawings, wherein like reference numerals refer to like elements throughout. The embodiment is described below to explain the present invention by referring to the annexed drawings.

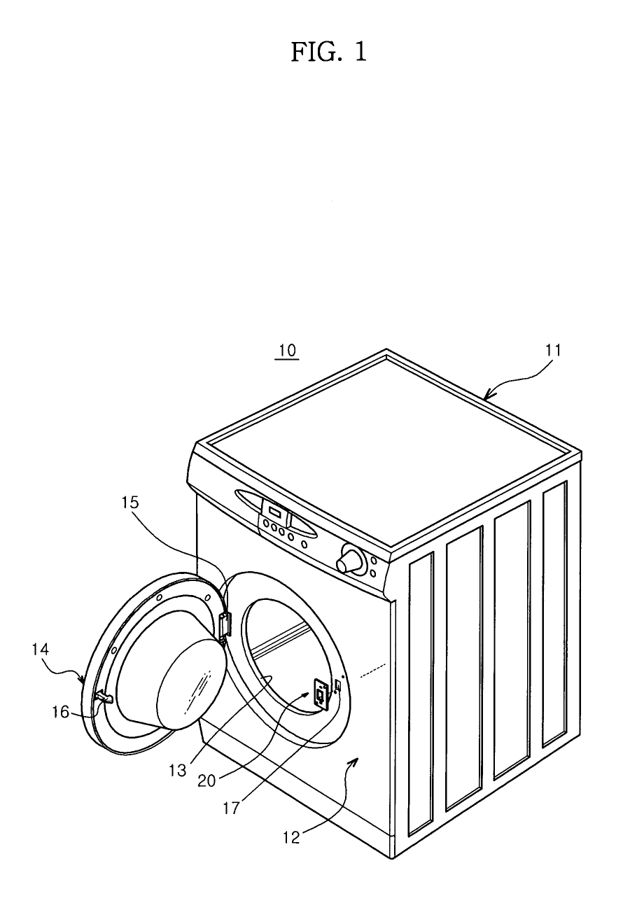

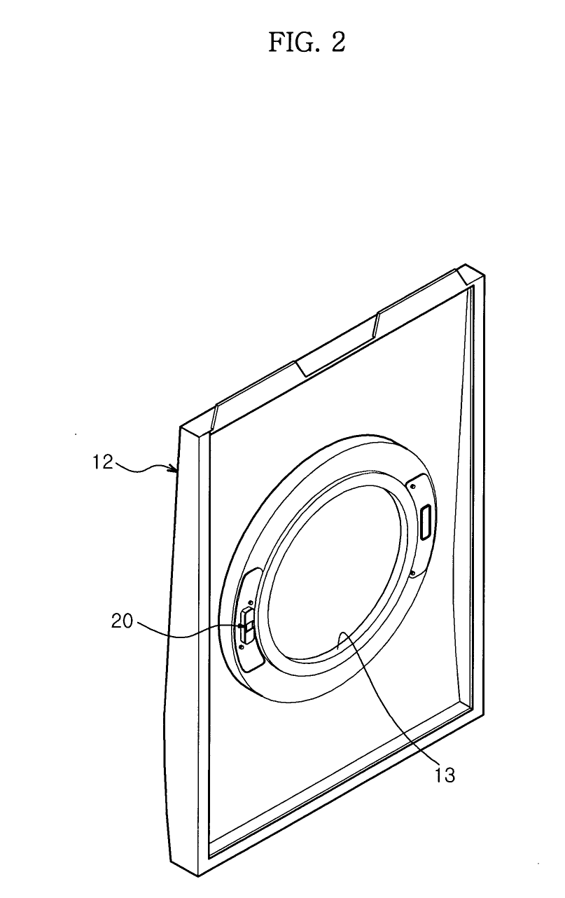

FIG. 1 is a front perspective view of the external appearance of a drying machine having a latch assembly in accordance with the present invention, and FIG. 2 is a rear perspective view of a front panel provided with the latch assembly, shown in FIG. 1, connected to the rear surface thereof.

As shown in FIG. 1, the drying machine 10 comprises a cabinet 11 having the opened front surface thereof, a front panel 12 installed on the opened front surface of the cabinet 11, and a door 14 for opening and closing a circular-shaped opening 13 formed through the central area of the front panel 12.

The door 14 is hinged to the front panel 12 by a hinge member 15 formed at one side of the opening 13, thereby being rotatably installed on the front panel 12. A hook 16 is protruded from one side of the rear surface of the door 14, opposite to the hinge member 15, toward the front panel 12.

A hole 17 is formed at the other side of the opening 13 in the front panel 12 opposite to the hinge member 15, and a latch assembly 20 of the present invention is installed in the hole 17. That is, when the latch assembly 20 is inserted into the hole 17 and screwed to the hole 17, as shown in FIG. 2, the latch assembly 20 passes through the hole 17 and protrudes toward the inside of the front panel 12, thereby being capable of locking or unlocking the hook 16 formed on the door 14, thus causing the door 14 to open and close the opening 13 formed through the front panel 12.

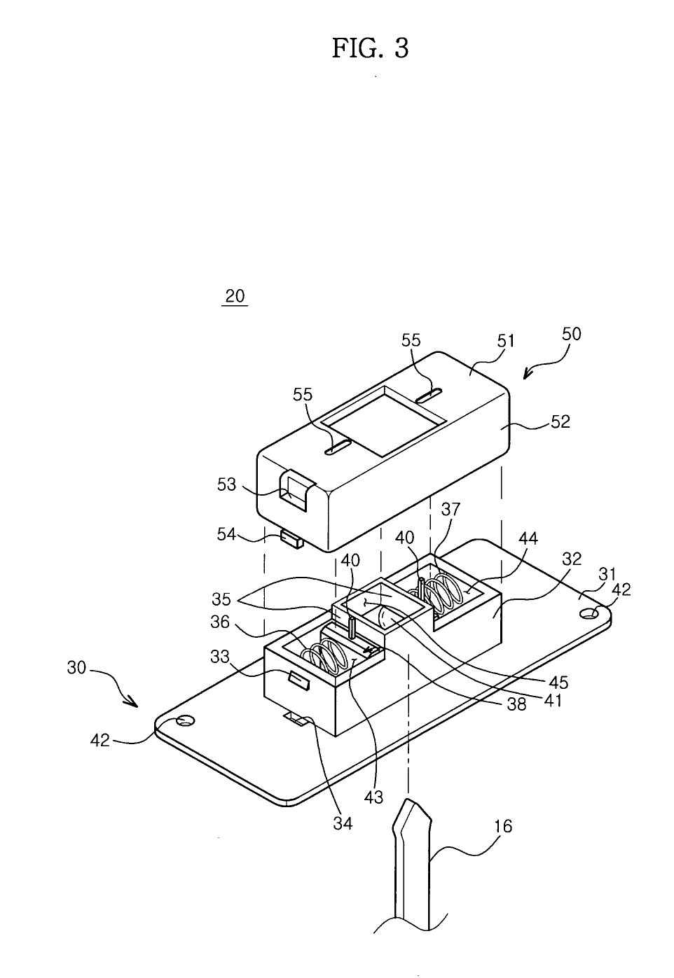

Hereinafter, with reference to FIGS. 3 to 5, the structure and function of the latch assembly 20 of the present invention will be described in detail.

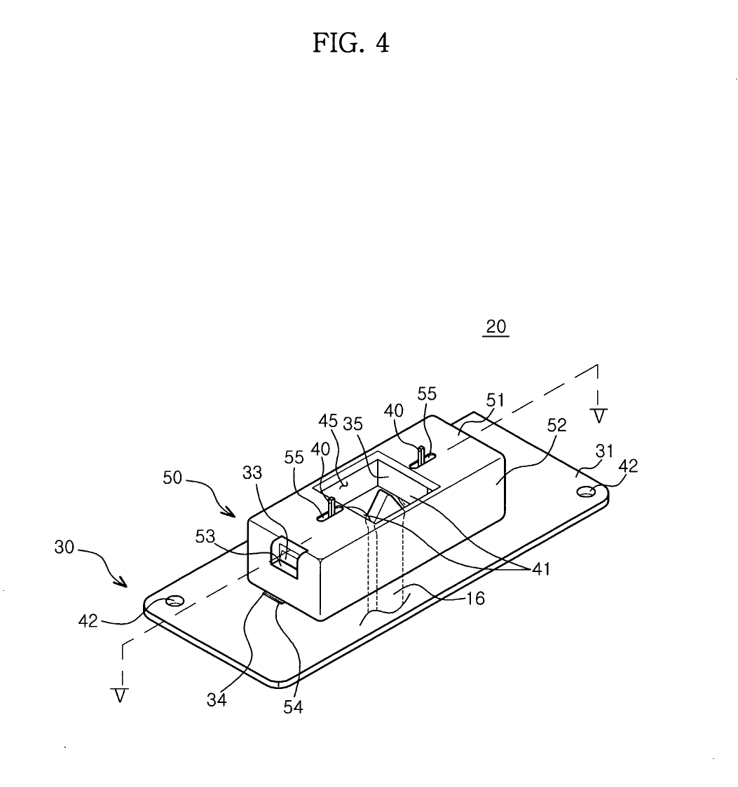

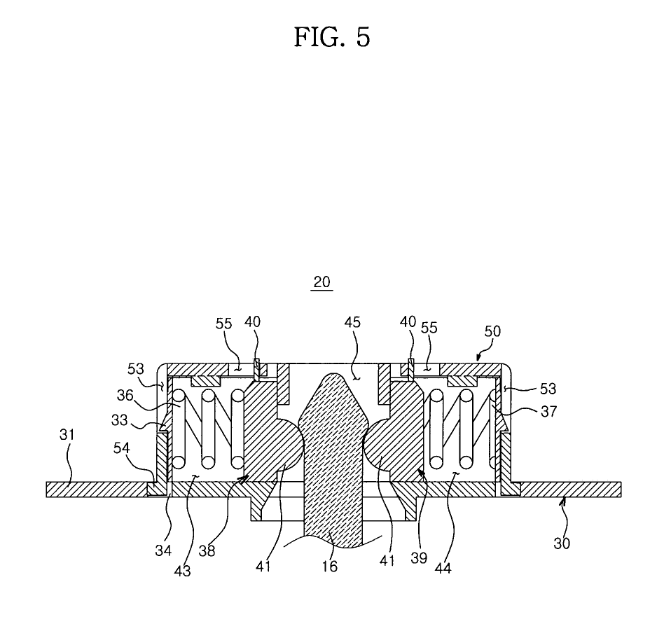

FIGS. 3 and 4 are respectively exploded and assembled perspective views of the latch assembly 20 consistent with the present invention, and FIG. 5 is a longitudinal-sectional view taken along the line V-V of FIG. 4.

As shown in FIG. 3, the latch assembly 20 includes a latch main body 30 for receiving or releasing the hook 16 installed on the door 14 to perform a locking or unlocking operation, and a latch cover 50 assembled with the latch main body 30.

The latch main body 30 includes a base portion 31 having a plate shape, and an operating portion 32 perpendicularly extended from the surface of the base portion 31 so as to have an approximately hollow hexahedral structure, thereby forming an external appearance. The latch cover 50 includes a planar portion 51 having a size corresponding to the size of the cross-section of the operating portion 32, and an extended portion 52 perpendicularly extended from the edge of the planar portion 51 so as to have a hollow hexahedral structure corresponding to the operating portion 32, thereby forming an external appearance.

Protrusions 33 are protruded from opposite side surfaces of the operating portion 32 of the latch main body 30, and fixing holes 34, which are positioned just below the protrusions 33 of the operating portion 32, are formed through opposite side surfaces of the base portion 31 of the latch main body 30 (with reference to FIG. 5).

Protrusion-receiving holes 53 corresponding to the protrusions 33 are formed through opposite side surfaces of the extended portion 52 of the latch cover 50, and fixing protrusions 54 corresponding to the fixing holes 34 of the latch main body 30 are protruded from ends of the opposite side surfaces of the extended portion 52 provided with the protrusion-receiving holes 53.

Accordingly, when the extended portion 52 of the latch cover 50 is placed on the operating portion 32 of the latch main body 30 and then pressed onto the operating portion 32 by a small intensity of force, as shown in FIG. 5, the operating portion 32 is inserted into the extended portion 52. Here, the protrusions 33 of the latch main body 30 are caught by the protrusion-receiving holes 53 of the latch cover 50, and simultaneously, the fixing protrusions 54 of the latch cover 50 are inserted into the fixing holes 34 of the latch main body 30, thereby assembling the latch cover 50 with the latch main body 30 in a one-touch fashion. Even when impact or vibration is applied to the latch main body 30 and the latch cover 50 or the latch main body 30 and the latch cover 50 are thermally deformed, the above assembly structure allows the latch cover 50 to maintain its firm fixation to the latch main body 30.

As shown in FIG. 3, the inside of the operating portion 32 of the latch main body 30 is divided into a first space 43, a second space 44, and a third space 45 communicating with the first and second spaces 43 and 44 through a pair of partitions 35 disposed in a transverse direction. The upper and lower surfaces of the third space 45 are opened so that the hook 16 of the door 14 is inserted into or separated from the operating portion 32 through the third space 45 (with reference to FIG. 5).

A first spring 36 and a first holder 38 are installed in the first space 43 such that the first spring 36 and the first holder 38 can move back and forth, and a second spring 37 and a second holder 39 are installed in the second space 44 such that the second spring 37 and the second holder 39 can move back and forth.

As shown in FIG. 5, each of the first holder 38 and the second holder 39 includes a guide protrusion 40 protruding toward the planar portion 51 of the latch cover 50, and a latch unit 41 protruded from the guide protrusion 40 toward the third space 45. The latch cover 50 includes a pair of guide holes 55 formed longitudinally along the first and second spaces 43 and 44.

Accordingly, when the latch cover 50 is inserted into the latch main body 30, as shown in FIGS. 4 and 5, the guide protrusions 40 of the first and second holders 38 and 39 pushed toward the third space 45 by the first and second springs 36 and 37 are respectively inserted into the guide holes 55 formed through the planar portion 51 of the latch cover 50, thereby causing the first and second holders 38 and 39 to move stably back and forth in the first and second spaces 43 and 44. The latch units 41 of the first and second holders 38 and 39 lock or unlock of the hook 16 by the above back and forth movement of the first and second holders 38 and 39.

Screw holes 42 are formed in two corners, which face diagonally, of the base portion 31 of the latch main body 30, thereby connecting the latch assembly 20 and the front panel 12 using screws.

Although the exemplary embodiment of the present invention describes the latch assembly 20 applied to the drying machine 10, the latch assembly 20 may be applied to other products provided with a door, such as a washing machine and a dishwasher.

As apparent from the above description, the present invention provides a latch assembly, in which a latch main body and a latch cover are firmly assembled in a one-touch fashion, and a drying machine having the latch assembly. Thereby, it is possible to assemble simply and rapidly the latch assembly and to maintain the firm fixation between the latch cover and the latch assembly even when impact or vibration is applied to the latch assembly or the latch assembly is thermally deformed.

Although an exemplary embodiment of the invention has been shown and described, it would be appreciated by those skilled in the art that changes may be made in this embodiment without departing from the principles and spirit of the invention, the scope of which is defined in the claims and their equivalents.

What is claimed is:

1. A latch assembly comprising:
a latch main body for locking or unlocking a hook installed on a door; and
a latch cover for covering the latch main body,
wherein the latch main body includes at least one protrusion, and the latch cover includes at least one protrusion-receiving hole, by which the protrusion is caught, so that the latch main body and the latch cover are assembled in a one-touch fashion.

2. The latch assembly according to claim 1,
wherein the latch main body includes a base portion, and an operating portion perpendicularly extended from a surface of the base portion, and the latch cover includes a planar portion, and an extended portion perpendicularly extended from an edge of the planar portion, so that the extended portion of the latch cover covers the operating portion of the latch main body.

3. The latch assembly according to claim 2,
wherein a pair of the protrusions are formed on an outer surface of the operating portion of the latch main body such that the protrusions are opposite to each other, and a pair of the protrusion-receiving holes corresponding to the protrusions are formed in two sides of the extended portion of the latch cover such that the protrusion-receiving holes are opposite to each other.

4. The latch assembly according to claim 3,
wherein fixing protrusions are formed on ends of the opposite sides of the extended portion of the latch cover provided with the protrusion-receiving holes, and fixing holes, into which the fixing protrusions are inserted, are formed in the base portion of the latch main body, thereby allowing the latch cover to be firmly fixed to the latch main body.

5. The latch assembly according to claim 2, wherein:
an inside of the operating portion of the latch main body is divided into a first space, a second space, and a third space communicating with the first and second spaces; and
a first spring and a first holder are installed in the first space, and a second spring and a second holder are installed in the second space, so that the hook moving toward the third space is locked or unlocked by the action of the first and second springs and the first and second holders.

6. The latch assembly according to claim 5,
wherein each of the first and second holders includes a guide protrusion protruding toward the planar portion of the latch cover, and a pair of guide holes for receiving and guiding the guide protrusions are formed through the planar portion of the latch cover, thereby allowing the first and second holders to stably move back and forth.

7. The latch assembly according to claim 5,
wherein each of the first and second holders includes a latch unit protruding toward the third space so that the first and second holders are pushed toward the third space by the first and second springs, thereby causing both side surfaces of the hook to be caught and locked by the latch units.

8. A drying machine comprising a front panel having an opening, a door hinged to the front panel to open and close the opening, a hook installed on the door, and a latch assembly installed in the front panel for locking and unlocking the hook,
wherein the latch assembly includes a latch main body having at least one protrusion, and a latch cover having at least one protrusion-receiving hole, by which the protrusion is caught, so that the latch main body and the latch cover are assembled in a one-touch fashion.

9. The drying machine according to claim 8,
wherein the latch main body includes a base portion, and an operating portion perpendicularly extended from a surface of the base portion, and the latch cover includes a planar portion, and an extended portion perpendicularly extended from an edge of the planar portion, so that the extended portion of the latch cover covers the operating portion of the latch main body.

10. The drying machine according to claim 9,
wherein a pair of the protrusions are formed on an outer surface of the operating portion of the latch main body such that the protrusions are opposite to each other, and a pair of the protrusion-receiving holes corresponding to the protrusions are formed in two sides of the extended portion of the latch cover such that the protrusion-receiving holes are opposite to each other.

11. The drying machine according to claim 10,
wherein fixing protrusions are formed on ends of the opposite sides of the extended portion of the latch cover provided with the protrusion-receiving holes, and fixing holes, into which the fixing protrusions are inserted, are formed in the base portion of the latch main body, thereby allowing the latch cover to be firmly fixed to the latch main body.

12. The drying machine according to claim 9, wherein:
an inside of the operating portion of the latch main body is divided into a first space, a second space, and a third space communicating with the first and second spaces; and
a first spring and a first holder are installed in the first space, and a second spring and a second holder are installed in the second space, so that the hook is locked or unlocked by the action of the first and second springs and the first and second holders.

13. The drying machine according to claim 12,
wherein each of the first and second holders includes a guide protrusion protruding toward the planar portion of the latch cover, and a pair of guide holes for receiving and guiding the guide protrusions are formed through the planar portion of the latch cover, thereby allowing the first and second holders to stably move back and forth.

14. The drying machine according to claim 12,
wherein each of the first and second holders includes a latch unit protruding toward the third space so that the first and second holders are pushed toward the third space by the first and second springs, thereby causing both side surfaces of the hook to be caught and locked by the latch units.

15. The drying machine according to claim 9,
wherein a plurality of screw holes are formed in the base portion of the latch assembly, thereby connecting the latch assembly to the front panel using screws.
